(19) United States
(12) Patent Application Publication
(10) Pub. No.: US 2009/0217542 A1
(43) Pub. Date: Sep. 3, 2009

(54) MEASURING ROLLER AND SPRAY DEVICE

(76) Inventor: Nathan P. Watkins, Beaufort, SC (US)

Correspondence Address: ADAMS INTELLECTUAL PROPERTY LAW, P.A., Suite 2350 Charlotte Plaza, 201 South College Street, CHARLOTTE, NC, 28244, US

(21) Appl. No.: 12/464,945

(22) Filed: May 13, 2009

Related U.S. Application Data
(63) Continuation-in-part of application No. 12/064,495, filed on Feb. 22, 2008.
(60) Provisional application No. 60/710,739, filed on Aug. 24, 2005.

(51) Int. Cl. G01B 3/12

(52) U.S. Cl. 33/775; 33/772

(57) ABSTRACT

A measuring device includes a frame, a rolling wheel carried by the frame, measuring means for determining a distance traveled by the wheel, and signal means responsive to the measuring means for indicating when the wheel has traveled a preselected set distance. The measuring device may also include marking means such as spray paint, a braking mechanism, and a sonar position indicator.

### CROSS REFERENCE TO RELATED APPLICATIONS

This application is a continuation in part application of U.S. patent application Ser. No. 12064495 which in turn is a National Stage application of PCT/US2006/033116 which claims priority to U.S. Provisional Application Ser. No. 60/710,739 which was filed on Aug. 24, 2005.

### TECHNICAL FIELD AND BACKGROUND OF THE INVENTION

This invention relates generally to measuring devices, and more particularly to roller and spray devices for marking locations.

Handheld devices that mark the ground with spray paint or other marking substances at the user's direction are well known. These devices rely either on sight or a lever actuated wheel connected to a counter to indicate the appropriate spraying area. They are used, for example, to line fields for outdoor sporting events, such as football, soccer, and baseball. The devices are also used by individuals to mark a surface indicating an underground structure, or to mark the location of landscaping features. However, all of these devices require the user to rely on their best judgment or to monitor the attached measurement device closely and manually spray the paint at the correct location.

### SUMMARY OF THE INVENTION

Therefore, it is an object of the invention to provide a device that alerts a user after a preset distance has been traversed.

It is another object of the invention to provide a device that automatically sprays paint or other marking substance after a preset distance has been traveled.

It is another object of the invention to provide a device with an electronic counter that measures, in commonly used landscaping increments, the distance traveled by a wheel, which is preset by the user and notifies the user when the preset distance has been traversed.

It is another object of the invention to provide a braking mechanism to stop rotation of the rolling wheel.

It is another object of the invention to provide a location indicator.

These and other objects are achieved by the present invention, which in one aspect provides a measuring device including a frame, a rolling wheel carried by the frame, measuring means for determining a distance traveled by the wheel, and signal means responsive to the measuring means for indicating when the wheel has traveled a preselected set distance.

According to another aspect of the invention, the measuring means comprises a sensor operatively coupled to the rolling wheel.

According to another aspect of the invention, the measuring device includes marking means for discharging a marking material on a surface traversed by the rolling wheel.

According to another aspect of the invention, the signal means include at least one mechanical counter driven by the rolling wheel and adapted to generate a signal when the set distance is reached.

According to another aspect of the invention, the signal means includes at least one mechanical counter driven by the rolling wheel and adapted to generate a signal when the set distance is reached.

According to another aspect of the invention, the measuring device includes marking means responsive to the signal means for discharging a marking material on a surface traversed by the rolling wheel when the wheel has traveled the preselected set distance.

According to another aspect of the invention, the measuring device includes a braking mechanism.

According to another aspect of the invention, the braking mechanism includes an actuator and a stopping member connected to the actuator and located near the rolling wheel. The stopping member is movable between a first position and a second position. The stopping member does not engage the rolling wheel when the stopping member is in the first position. The stopping member engages the rolling wheel when the stopping member is in the second position such that the stopping member retards rolling movement of the rolling wheel.

According to another aspect of the invention, the actuator includes a pivotable eccentric lever and a push rod having a first end connected to the eccentric lever and a second end connected to the stopping member.

According to another aspect of the invention, the measuring device includes a biasing element aligned with the push rod for biasing the stopping member towards the first position.

According to another aspect of the invention, the measuring device includes a location indicator. The location indicator includes a sonar emitting device and a receiver, and is configured to provide a signal indicative of the distance of the measuring device from a predetermined surface.

According to another aspect of the invention, a measuring device is provided that includes a frame, a rolling wheel carried by the frame, a sensor for measuring a distance traveled by the wheel, and a counter for determining when the wheel has traveled a preselected set distance and generating a sensory indication in response thereto.

According to another aspect of the invention, the sensory indication is a visible indication.

According to another aspect of the invention, the measuring device includes a spray device marking means for discharging a marking material on a surface traversed by the rolling wheel.

According to another aspect of the invention, the counter comprises at least one mechanical counter driven by the rolling wheel and adapted to generate a signal when the set distance is reached.

According to another aspect of the invention, the signal means is operable to generate an audible signal.

According to another aspect of the invention, the measuring means comprises a sensor operatively coupled to the rolling wheel.

According to another aspect of the invention, the marking means includes a holder for a pressurized can.

### BRIEF DESCRIPTION OF THE FIGURES

The subject matter that is regarded as the invention may be best understood by reference to the following description taken in conjunction with the accompanying drawing figures in which:

FIG. 1 is a perspective view of a roller and spray device constructed according to an embodiment of the invention;

FIG. 2 is a perspective view of a control box, trigger, and handle of the device of FIG. 1;

FIG. 3 is an exploded perspective view of the device of FIG. 1;

FIG. 4 is a perspective view of a roller and spray device constructed according to another aspect of the invention;

FIG. 5 is a schematic top view of a mechanically operated repeat counter;

FIG. 6 is a perspective view of a cam attached to a number wheel;

FIG. 7 is a side view of a braking mechanism in a first disengaged position;

FIG. 8 is a perspective view of a braking mechanism in a first disengaged position;

FIG. 9 is a side view of a braking mechanism in a second engaged position;

FIG. 10 is a perspective view of a braking mechanism in a second engaged position;

FIG. 11 is an enlarged perspective view of a braking mechanism in a second engaged position; and

FIG. 12 is a perspective view of location indicator.

### DESCRIPTION OF THE PREFERRED EMBODIMENT AND BEST MODE

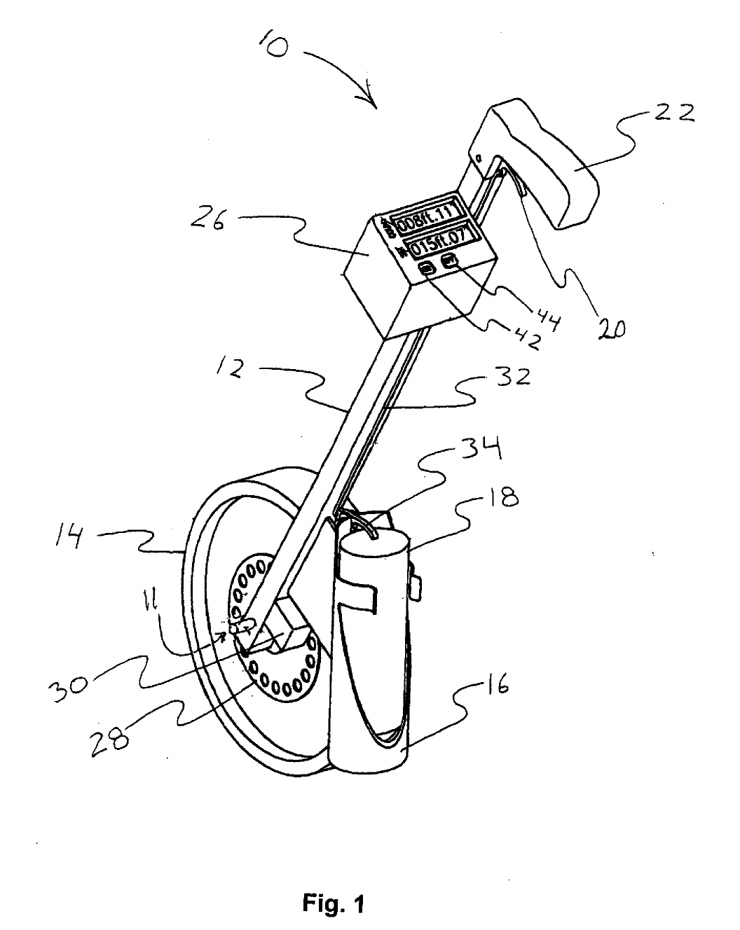

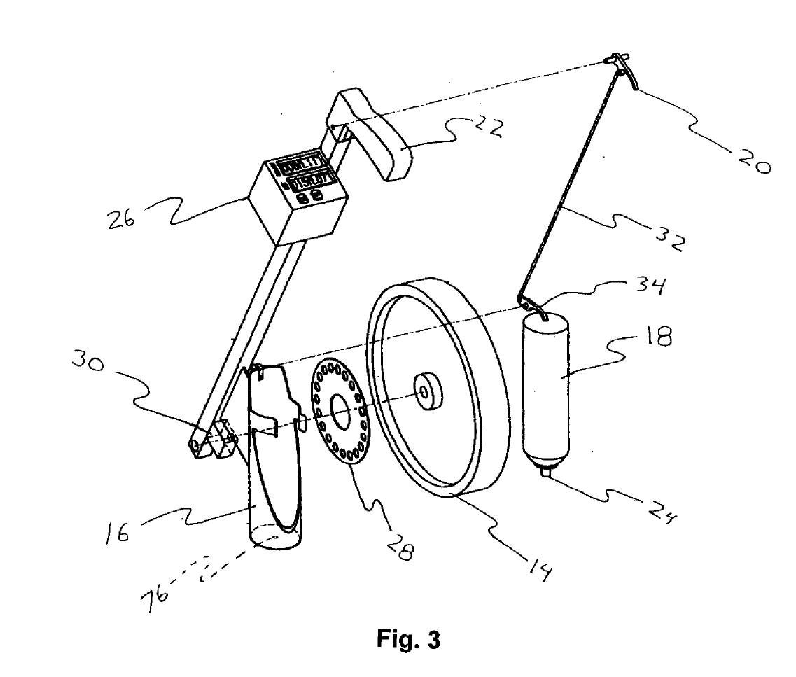

Referring now specifically to the drawings, an exemplary measuring roller and spray device is illustrated in FIGS. 1-4 and is shown generally at reference numeral 10. An elongate frame 12 has a first end and a second end. A rolling wheel 14 is carried at or near the first end of the frame 12 along with a holder 16 to hold a pressurized can 18 of spray paint or other suitable marking material positioned downward. The second end of the frame 12 is equipped with a trigger 20 positioned below a handle 22 and operable to depress or otherwise actuate the nozzle 24 of the can 18, thereby releasing the spray paint. A control box 26, which displays the distance the rolling wheel 14 has traveled, is located in close proximity to the handle 22. The control box 26 may include a battery or other power supply and a programmable electronic counting and control device (not shown) of a known type

As illustrated in FIG. 1, an encoder wheel 28 is axially positioned adjacent the rolling wheel 14 with a encoder sensor 30, for example a photosensor, located in close proximity. The encoder sensor 30 senses movement of the encoder wheel 28, which is calibrated to accurately determine the distance the rolling wheel 14 has traversed. The sensor 30 communicates the distance traveled to the control box 26 (e.g. using a cable or wireless connection) as the rolling wheel 14 rotates.

The trigger 20 is pivotally connected to the second end of the elongate frame 12, under the handle 22. A trigger rod 32 extends from the trigger 20, along the elongate frame 12, and pivotally connected to the can holder 16. An arm 34 extends outward from the trigger rod 32 over the bottom portion of the can 18. Operation of the trigger 20 causes the trigger arm 34 to force the can 18 downward, thus depressing the nozzle 24 and discharging the can 18. In another embodiment (not shown), the trigger rod 32 extends to the nozzle of the can, with the arm 34 extending outward so as to depress the nozzle when the trigger 20 is actuated.

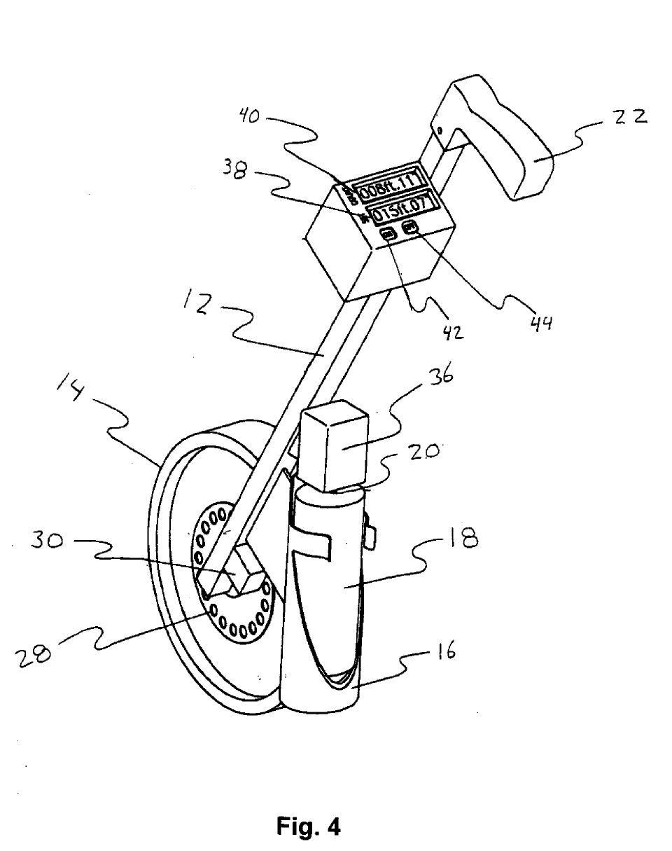

As illustrated in FIG. 4, the manual trigger 20 and associated mechanism can be replaced by a trigger actuator 36 (e.g. solenoid or other suitable actuator) positioned directly above the bottom of the can 18. The trigger actuator 36 contains a trigger 20′ operable to depresses the can 18 in response to a signal from the control box 26 once the preset distance has been traveled. In another embodiment (not shown), the trigger 20′ could also be located in close proximity to the nozzle 24 of the can 18, so as to directly depress or otherwise actuate the nozzle 24 once the preset distance has been achieved.

It is also noted that any type of container and spraying equipment suitable to dispense paint or a marking material could be substituted for the pressurized can 18 described above. For example, a permanent refillable container could be used.

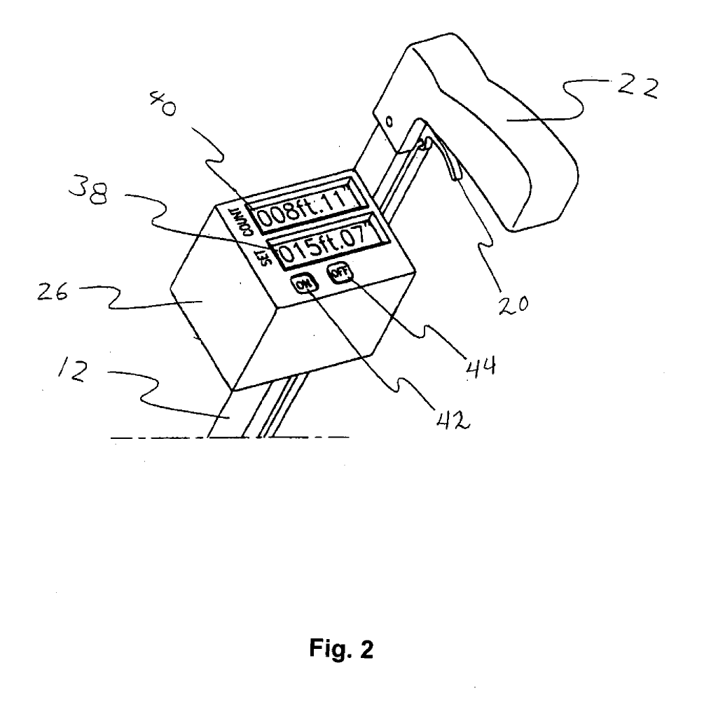

The control box 26 can be positioned at any convenient location on the frame 12. The control box 26 may be located in close proximity to the handle 22 so that it can be easily set, seen, and read by a user. As shown in FIG. 2, the control box 26 includes electronic or mechanical counters with digital or number wheel displays. A set distance counter 38 displays the preset distance measurement, which is determined by the user. During use, the control box 26 measures, in response to the sensor 30, the distance the rolling wheel 14 has traveled, and displays the measurements in convenient units, such as meters, feet, centimeters, or inches, on a count distance counter 40. The control box 26 also produces a sensory indication to alert the user after the preset distance has been achieved. The sensory indication may be any device or signal that alerts the user that a predetermined distance has been traveled. Sensory indicators could include a flash of light, a noise, a vibration, or any other type of indication that stimulates the sensory organs. The sensory indicators can be adjusted to provide a satisfactory amount of notification to the user based upon the individual requirements of his sensory organs.

For an electronic counter, an “on” switch 42 and an “off” switch 44 are located on the control box 26 enabling a user to selectively operate the control box 26 to conserve power. The preset distance may be input to the control box 26, for example, by a predefined sequence of keystrokes of the switches 42 and 44.

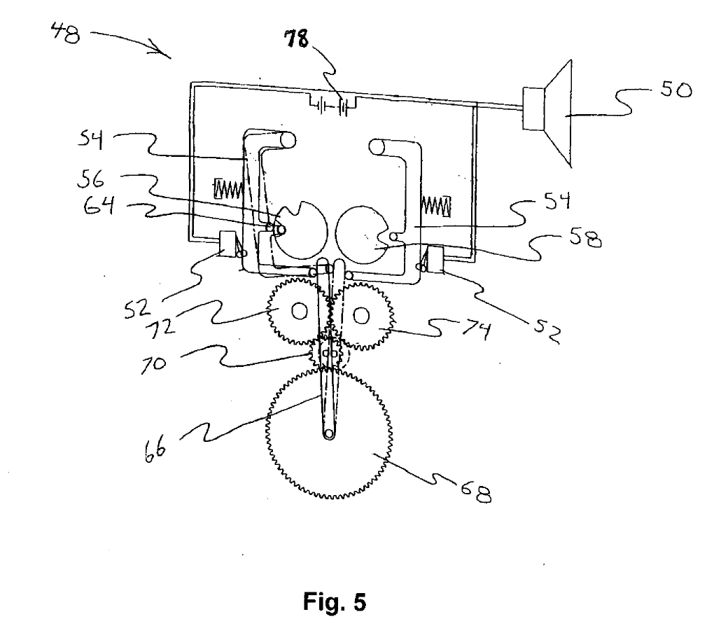

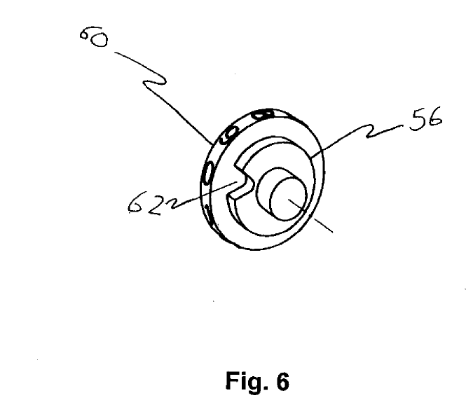

FIG. 5 illustrates one example of a repeat counter 48 that can be used to produce a signal indication from a signaling device 50 (such as an audio speaker) after a preset distance has been traveled. The repeat counter 48 includes a plurality of signal switches 52 adjacent to a plurality of spring loaded actuators 54. Two cams 56 and 58, each representative of a plurality of in-line cams are located adjacent the actuators 54. Each of the cams are attached to a number wheel 60 and have a detent 62 formed therein, as shown in FIG. 6. The detents 62 are aligned with a respective actuator extension 64, as illustrated in FIG. 5. A switch lever 66 is positioned between the distal ends of the actuators 54, extending vertically downward and connected to the axis of a drive gear 68, and a switch gear 70. The drive gear 68 is mounted on the encoder wheel 28, and engaged with the switch gear 70. A first counter gear 72 is integrally engaged with an adjacent second two gear 74. Depending on the position of the lever 66, either the first counter gear 72 or the second counter gear 74 is driven by the switch gear 70, thereby dictating the rotational direction of the first and second counter gears 72 and 74.

The repeat counter 48 operates like a conventional mechanical counter. As the rolling wheel 14 is rolled along a surface (i.e. clockwise), the drive gear 68 rotates, which in turn rotates the switch gear 70. The rotational movement of the switch gear 70 drives the first counter gear 72, which in turn drives the second counter gear 74. As the drive gear 68 rotates, the first counter gear 72 rotates clockwise, driving the second counter gear 74 counterclockwise. The movement of the counter gears 72, 74 operates the set distance counter 38 and count distance counter 40 in a known manner. The clockwise movement of the counter one gear 72 causes the set distance counter 40 to count down from the set distance to zero.

The counter clockwise movement of the second counter gear 74 causes the count distance counter 38 to count up from zero. When the set distance counter 40 reaches zero, all cam detents 62 of the set distance counter 40 are aligned with the actuator extension 64, allowing the counter one actuator 54 to move forward under the urging of the illustrated spring, which pushes the switch lever 66 horizontally. This horizontal movement of the switch lever engages the switch gear 70 with the second counter gear 74. As the first counter actuator 54 moves, the signal switch 52 is released, closing the circuit powered by the battery 78, and producing a signal indication from the signaling device 50. This causes the direction of counting to reverse, whereby the set distance counter 38 counts up from zero, and the count distance counter 40 counts down to zero. When the count distance counter 40 reaches zero, the second counter actuator 54 triggers the signaling device as described above and the switch lever 66 is pushed back to the left to start the cycle again. Thus, a set distance may be repeatedly measured with a single setting of the set distance.

According to another embodiment (not shown), a lever actuated counter is operable to measure the rotations of the rolling wheel. This counter includes a wire that extends from the wheel to a sensor, having a spring contained therebetween. One end of the wire is connected to a lever located on the sensor, while the other end of the wire is connected to the wheel. With each rotation of the wheel, the wire converts rotational movement of the wheel into radial deformation of the spring that pulls the lever, thereby actuating the sensor in communication with the control box to display the distance traveled.

To use the device 10, the user inputs a distance measurement into the set distance counter 40. Then, the user rolls the measuring roller and spray device 10 along a surface. As the rolling wheel 14 rotates, the encoder wheel 28, attached thereto, rotates also, providing the encoder sensor 30 with a measurement. The encoder sensor 30 is in continuous communication with the control box 26 to provide an accurate account of the distance traveled, which is displayed for the user (e.g. on the count distance display 38). Once the distance has been achieved, as determined by the control box 26 or the mechanical repeat counter 48, a sensory indication is triggered alerting the user of the need to pull the trigger 20.

Alternatively, the paint may be automatically sprayed by operation of the trigger actuator 36 in response to a signal from the control box 26, as shown in FIG. 4. For example, once the set distance has been traveled, the trigger actuator 36 is automatically activated. The trigger actuator 36 depresses the trigger 20′, which produces a compression force on the bottom of the can. This compression force engages the nozzle 24, causing paint to be expelled through the hole 76 in the can holder 16 without the need for the user to manually pull a trigger. If automatically triggered, the duration of the spray may be controlled by the control box 26, based on time or distance.

The device 10 may also include a lateral buffering means. For example, a measuring device 11 such as a mechanical gage, laser, or ultrasonic sensor may be mounted on the frame 12 and arranged to measure the distance of an object from the frame in a lateral direction (e.g. parallel to the rotational axis of the rolling wheel 14). The measuring device 11 may be connected to the control box 26 and programmed to accept a present lateral distance, selectable by the user. The device 10 may then be rolled along a curb, wall, row of plants, etc. at then known lateral distance. If the device 10 varies from the present lateral distance, the control box 26 would sense the variation in measurement from the measuring device 11 and then generate a sensory indication as noted above to alert the user. Preferably, the sensory indication would be distinguishable from the sensory indication which indicates that a mark is to be applied. For example, two different audible tones could be used. The lateral buffering may be used if spraying is automatic as described above.

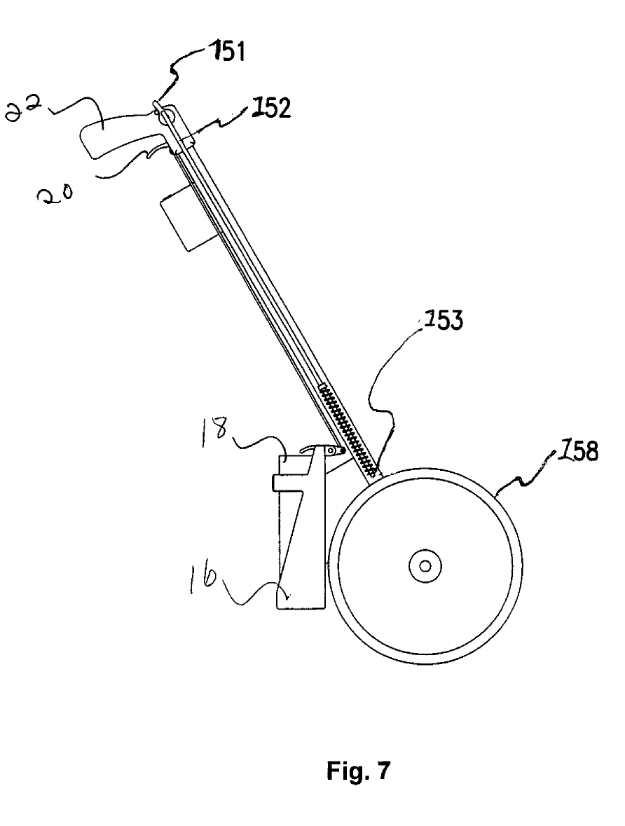

As shown in FIG. 7, a braking mechanism is generally shown according to another embodiment of the present invention. The mechanism includes a pivotable eccentric lever 151 configured to impart linear movement to a push rod 152 upon rotation of the pivotable eccentric lever 151. The push rod 152 is connected to a stopping member 153. The stopping member is located proximal to a rolling wheel 158. The stopping member 153 is in the disengaged position as shown in FIG. 7, where the disengaged position is defined by the lack of contact between the stopping member 153 and the rolling wheel 158.

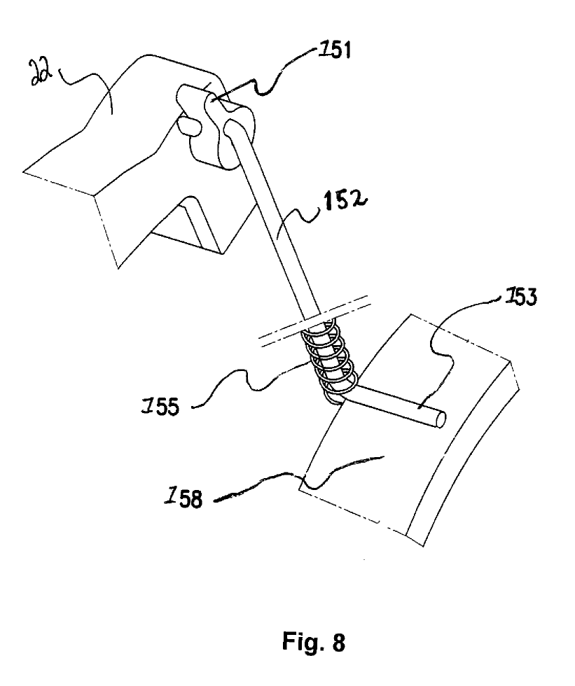

As shown in FIG. 8, the braking mechanism of FIG. 7 is shown in an enlarged view. A biasing spring 155 is provided about the push rod 152. The biasing spring 155 maintains the braking mechanism in the disengaged position, until the operator rotates the pivotable eccentric lever 151 thereby imparting linear movement to the push rod 152 and stopping member 153.

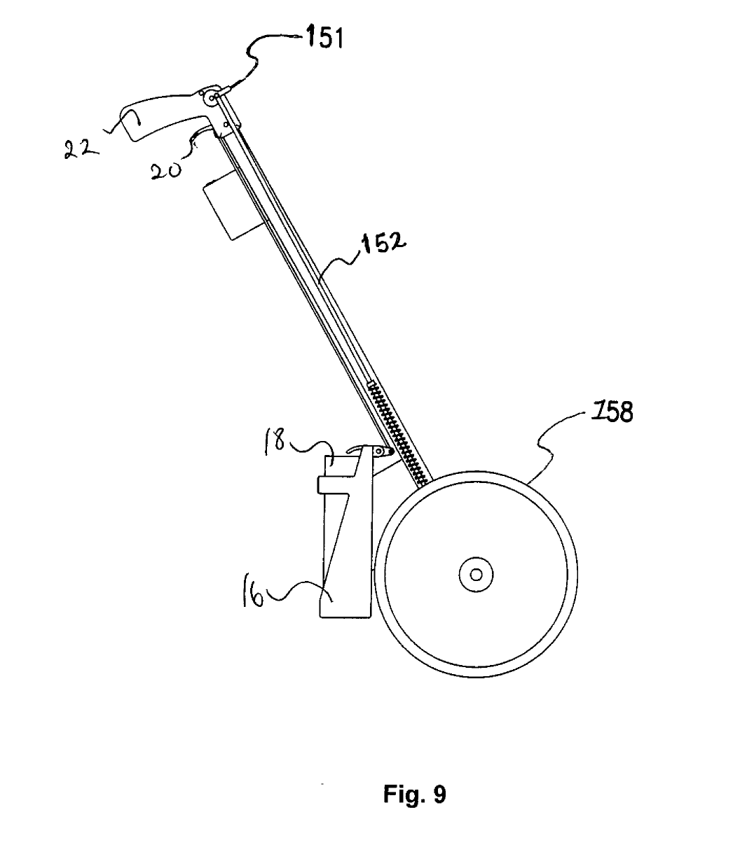

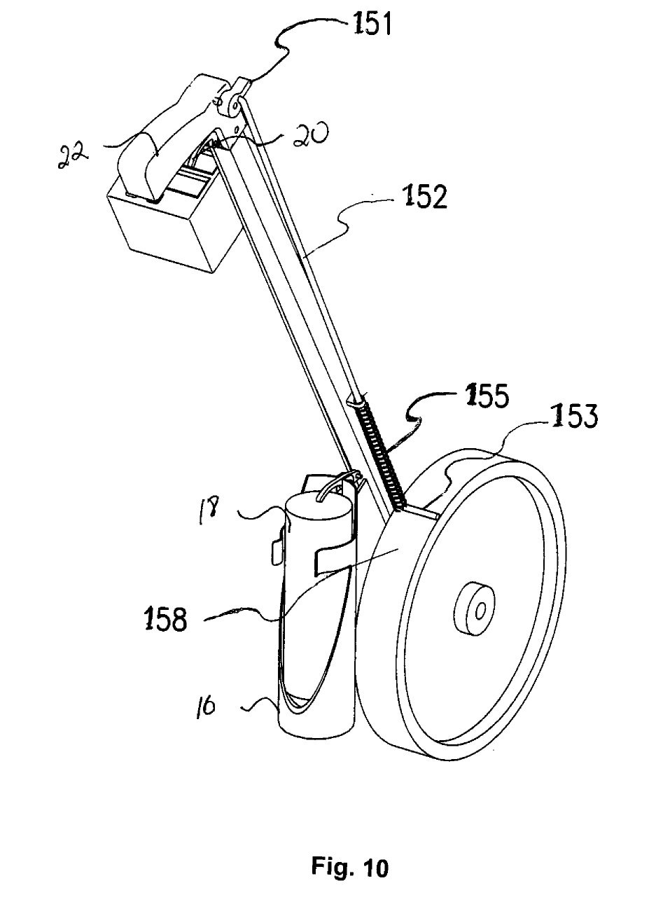

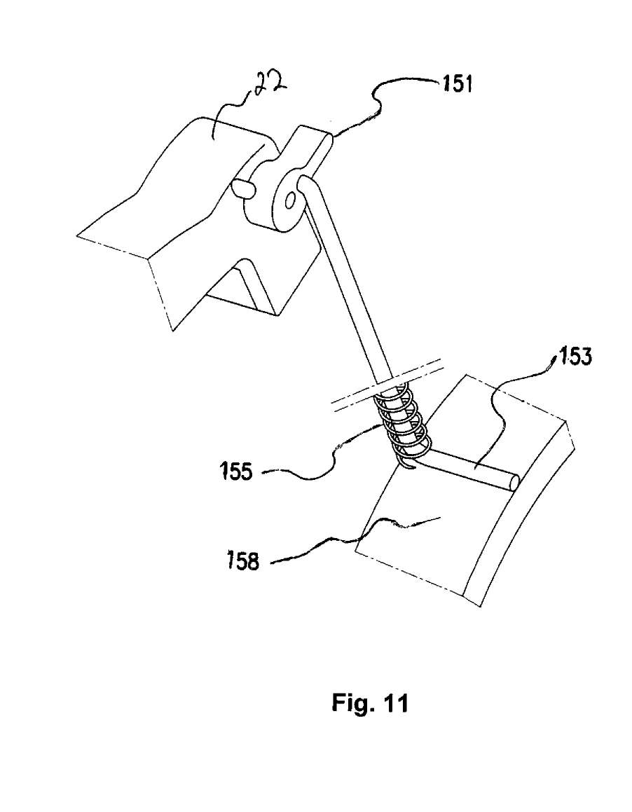

As shown in FIGS. 9, 10, and 11, the stopping member is in the engaged position. The braking mechanism is placed in the engaged position by rotation of the pivotable eccentric lever in a clockwise direction. This causes the push rod 152 and the stopping member 153 to move towards and into contact with the rolling wheel 158 where the stopping member 153.

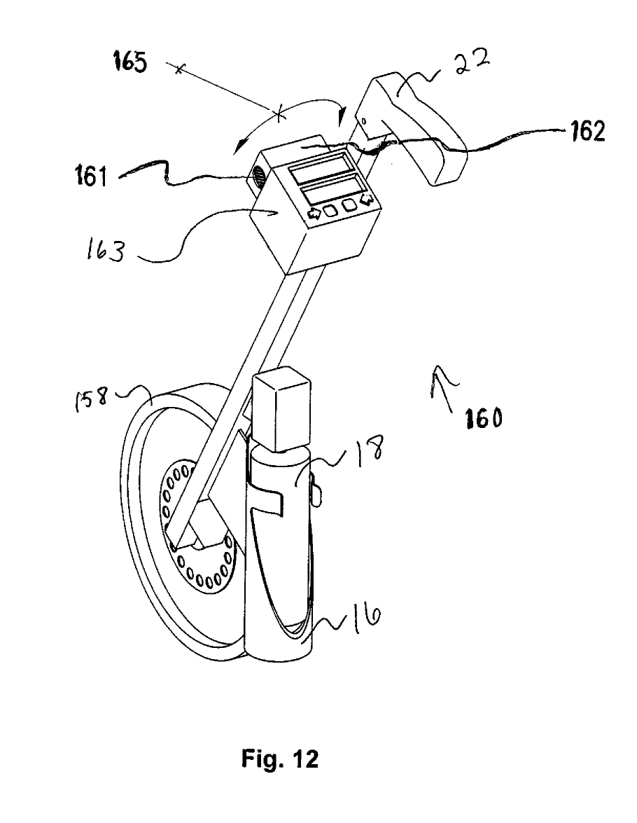

As shown in FIG. 12, a location indicator 160 is provided. The location indicator includes a sonar element 161 mounted on a sonar box 162 and configured to electronically communicate with the sonar computer 163. The sonar box 162 can be rotated to face any desired direction. The sonar computer 163 provides an indication to the operator to move the location indicator 160 to the left or right if the operator is off course. The sonar indicator could, for example, be used to determine distance from a wall within a sports stadium and could therefore maintain generally parallel travel respective of the wall.

A measuring roller and spray device is described above. Various details of the invention may be changed without departing from its scope. Furthermore, the foregoing description of the preferred embodiments of the invention and the best mode for practicing the invention are provided for the purpose of illustration only and not for the purpose of limitation.

What is claimed is:

1. A measuring device, comprising:
a frame;
a rolling wheel carried by the frame;
measuring means for determining a distance traveled by the wheel; and
signal means responsive to the measuring means for indicating when the wheel has traveled a preselected set distance.

2. The measuring device of claim 1 wherein the measuring means comprises a sensor operatively coupled to the rolling wheel.

3. The measuring device of claim 1 further including marking means for discharging a marking material on a surface traversed by the rolling wheel.

4. The measuring device of claim 1 wherein the signal means comprises at least one mechanical counter driven by the rolling wheel and adapted to generate a signal when the set distance is reached.

5. The measuring device of claim 1 further including marking means responsive to the signal means for discharging a marking material on a surface traversed by the rolling wheel when the wheel has traveled the preselected set distance.

6. The measuring device of claim 1, further including a braking mechanism.

7. The measuring device of claim 6, wherein the braking mechanism includes:
an actuator;
a stopping member connected to the actuator and located near the rolling wheel; and
the stopping member being movable between a first position and a second position, wherein the stopping member does not engage the rolling wheel in the first position, and the stopping member engages the rolling wheel in the second position such that the stopping member retards rolling movement of the rolling wheel when in the second position.

8. The measuring device of claim 7, wherein the actuator includes a pivotable eccentric lever and a push rod having a first end connected to the eccentric lever and a second end connected to the stopping member.

9. The measuring device according to claim 8, further including a biasing element aligned with the push rod for biasing the stopping member towards the first position.

10. The measuring device of claim 1, further including a location indicator, wherein the location indicator includes a sonar emitting device and a receiver, and is configured to provide a signal indicative of distance from a predetermined surface.

11. A measuring device, comprising:
a frame;
a rolling wheel carried by the frame;
a sensor for measuring a distance traveled by the wheel; and
a counter for determining when the wheel has traveled a preselected set distance and generating a sensory indication in response thereto.

12. The measuring device of claim 11 wherein the sensory indication is a visible indication.

13. The measuring device of claim 11 further including a spray device marking means for discharging a marking material on a surface traversed by the rolling wheel.

14. The measuring device of claim 11 wherein the counter comprises at least one mechanical counter driven by the rolling wheel and adapted to generate a signal when the set distance is reached.

15. The measuring device of claim 11, further including a braking mechanism.

16. The measuring device of claim 15, wherein the braking mechanism includes:
an actuator;
a stopping member connected to the actuator and located near the rolling wheel; and
the stopping member being movable between a first position and a second position, wherein the stopping member does not engage the rolling wheel in the first position, and the stopping member engages the rolling wheel in the second position, such that the stopping member retards rolling movement of the rolling wheel in the second position.

17. The measuring device of claim 16, wherein the actuator includes a pivotable eccentric lever and a push rod having a first end connected to the eccentric lever and a second end connected to the stopping member.

18. The measuring device according to claim 17, further including a biasing element aligned with the push rod for biasing the stopping member towards the first position.

19. The measuring device of claim 11, further including a location indicator, wherein the location indicator includes a sonar emitting device and a receiver, and is configured to provide a signal indicative of distance from a predetermined surface.
